(19) United States
(12) Patent Application Publication
(10) Pub. No.: US 2015/0114180 A1
(43) Pub. Date: Apr. 30, 2015

(54) APPARATUS AND PROCESS FOR SURFACE GASIFICATION IN A REDUCTION REATOR SHAFT

(71) Applicant: SIEMENS VAI METALS TECHNOLOGIES GMBH, Linz (AT)

(72) Inventors: Georg Aichinger, Asten (AT); Karl-Heinz Beham, Hausmening (AT); Reinhard Pum, Traun (AT); Wolfgang Sterrer, Gampern (AT); Kurt Wieder, Schwertberg (AT); Johann Wurm, Bad Zell (AT)

(21) Appl. No.: 14/390,813

(22) PCT Filed: Apr. 18, 2013
(86) PCT No.: PCT/EP2013/058048

§ 371 Date: Oct. 6, 2014

(30) Foreign Application Priority Data
Apr. 18, 2012 (EP) 12164635.0

(51) Int. Cl. C21B 13/02; F27B 15/10; C21B 13/00

(52) U.S. Cl. CPC C21B 13/02; C21B 13/0033; F27B 15/10
USPC 75/415; 266/172; 75/444

(57) ABSTRACT

Apparatus for production of metal sponge or pig iron from metal oxide containing material in piece form using a reduction gas. A reduction reactor shaft (1); reduction gas inlet lines into the interior of the reduction reactor shaft (1); a reduction gas channel body (11) passes through the interior of the reduction reactor shaft (1) for distributing reduction gas; a reduction gas supply line for reduction gas and located below the reduction gas channel body (11) at at least one inner-wall end of the reduction gas channel body (11). The reduction gas channel body (11) has a carrier tube through which a cooling medium can flow. A first portion of the reduction gas is introduced into the bed by reduction gas inlet lines which end in the interior of the reduction reactor shaft. A second portion of the reduction gas is distributed into the bed by the reduction gas channel body. The second portion is supplied essentially vertically below the reduction gas channel body into the interior of the reduction reactor shaft.

### CROSS-REFERENCE TO RELATED APPLICATIONS

The present application is a 35 U.S.C. §§371 National Phase conversion of PCT/EP2013/058048, filed Apr. 18, 2013, which claims priority of European Patent Application No. 12164635.0, filed Apr. 18, 2012, the contents of which are incorporated by reference herein. The PCT International Application was published in the German language.

### TECHNICAL FIELD

The present invention relates to an apparatus for producing metal sponge or pig iron from material in the form of pieces containing metal oxide by using a reduction gas. The apparatus comprises a reduction reactor shaft and a number of reduction gas inlet lines ending in the interior of the reduction reactor shaft for introduction of the reduction gas into the interior of the reduction reactor shaft.

### PRIOR ART

Sponge iron may be produced by conversion of material containing iron oxide which is present as a bed in a reduction shaft. The conversion is performed with a reduction gas. The reduction gas is mostly introduced into the reduction shaft essentially via a so called bustle pipe, also referred to as a bustle for short. The pipe runs in the shape of a ring around the mostly complete circumference of the reduction shaft. The bustle is connected by so-called bustle slots to the interior of the reduction shaft which is filled with the material containing iron oxide. The bustle can be disposed within a fireproof outer wall of the reduction shaft, which is a so-called internal bustle, or can be disposed outside the reduction shaft, which is a so-called external bustle. Via openings emanating from the internal bustle or connected to the external bustle in the fireproof outer wall of the reduction shaft, which are so called bustle slots, reduction gas is distributed from the bustle into the reduction shaft. Usually, the bustle runs around the entire circumference of the reduction shaft and the bustle slots are then likewise disposed around the entire circumference since the reduction gas should be introduced evenly distributed for achieving an even reduction.

The reduction gas is generally distributed and introduced such that the bustle slots usually do not emerge into the area of the interior filled by the bed when the reduction shaft is in operation. For example, the reduction shaft is often manufactured with a jump in the expansion of the diameter of its inner space viewed vertically from above along the axis of the reduction shaft. The internal diameter is determined by the fireproof outer wall so that such an expansion, for example, can be realized by changing the thickness of the fireproof outer wall. As a result of the bed angle of the material containing iron oxide, a ring-shaped area not filled by the bed is formed at the expansion, which is also called the return around the entire circumference. The bustle slots then emerge into this ring-shaped area.

The reduction gas carries dust with it. After the gas is introduced into the reduction shaft, the dust is deposited in the ring-shaped area and in the bed of the material containing iron oxide. This causes an increased drop in pressure compared to dust-free gas from the circumference of the reduction shaft at which reduction gas is introduced towards the center of the bed because the deposited dust obstructs flow paths of the reduction gas through the bed. One of the consequences of this is an uneven gasification of the bed which causes a concomitant uneven reduction. When the material that has been reduced in the reduction shaft, for example sponge iron, for example as in a COREX® process is introduced into a melter gasifier, because of the low pressure in the center of the reduction shaft resulting from the obstructed flow paths, this can result in an unfavorable flow of heavily dust-laden gas from the melter gasifier via sponge iron conveyor lines into the reduction shaft, which is not desirable.

To even out the introduction of reduction gas into a reduction shaft and also to avoid the above noted problems resulting from a lower pressure in the center of a reduction shaft, compared to its circumference, it is proposed in EP0904415B1, in addition to a bustle with bustle slots, to provide further channels running from the outer side of the reduction shaft radially into the center arranged below the bustle for the introduction of reduction gas. Reduction gas is to be introduced via these channels not only at the circumference but also via a cross-sectional surface of the reduction shaft into the bed. The disadvantage in this case is that the channels according to EP0904415B1 must have expensive supports in the center of the reduction shaft. Because of the distance between bustle and channels, reduction gas for the channels cannot be directed from the bustle into the channels. With a plurality of channels and because of the cross-sectional surface that they occupy, blockages in the beds moving upwards can result. WO2009000409 proposes introducing the entire reduction gas via channels, without bustle, into the reduction shaft. Since the channels must introduce more reduction gas and are to be dimensioned correspondingly larger than in EP0904415B1, the problems of blockages are worsened. Furthermore the supply of gas to the cross-sectional surface of the shaft is more uneven compared to using a bustle.

A blast furnace process for producing pig iron is also known from the prior art which in a standard version is supplied with iron-bearing pieces of material and coke from above, and hot wind is blown in the lower area. More recent developments lead inter alia to the blast furnace being operated with technically pure oxygen and part of the furnace gas being supplied after processing as additional reduction gas to the blast furnace in the lower area of the shaft. Supply of reduction gas only via a bustle on the circumference likewise leads to uneven gas distribution in the blast furnace shaft.

WO0036159 and WO0036157 show how to introduce hot reduction gas into the reduction reactor shaft through a pipe passing through the interior of a reduction reactor shaft. This makes cooling the pipe, insulating the pipe and carrying the reduction gas through the wall of the pipe into the interior expensive.

### SUMMARY OF THE INVENTION

### Technical Task

The object of the present invention is to provide an apparatus and a process for production of sponge metal or pig iron from a bed of material containing metal oxide and using a reduction gas in a reduction reactor shaft, in which the problems of the prior art are avoided as far as possible.

### Technical Solution

This object is achieved by an apparatus for production of sponge metal or pig iron from a bed of material containing metal oxide by using a reduction gas, comprising
a reduction shaft,
a number of reduction gas inlet lines ending in the interior of the reduction reactor shaft for introduction of reduction gas into the interior of the reduction reactor shaft.

This apparatus is characterized by the presence of a reduction gas channel body passing through the interior of the reduction reactor shaft for distribution of reduction gas in the interior of the reduction reactor shaft, wherein
on at least one inner-wall-side end of the reduction gas channel body, essentially vertically below the reduction gas channel body, at least one reduction gas inlet line for supplying reduction gas below the reduction gas channel body is present in the interior of the reduction reactor shaft, and
the reduction gas channel body has a carrier tube through which a cooling medium can flow.

The metal sponge preferably involves sponge iron. Accordingly the material in the form of the pieces containing metal oxide preferably involves material in the form of pieces containing iron oxide. Material in the form of pieces is to be understood as material with a grain size of for example more than 5 mm, up to 50 mm in the case of sinter, up to 100 mm after agglomeration processes such as compacting. For example, the pieces are of lump ore, pellets or sinter.

A reduction reactor shaft is to be understood for example as a shaft reactor, such as is used for example in a COREX® process, or as the upper part of the blast furnace, i.e. the part of a blast furnace in which the indirect gas reduction takes place, above the cohesive zone. In a shaft reactor, solid metal sponge is produced for example, whereas in a blast furnace liquid raw iron is produced.

To introduce the reduction gas into the interior of the reduction reactor shaft a number of reduction gas inlet lines ending in the interior of the reduction gas reactor shaft are present. In such cases the ending in the interior formulation is to be understood as the reduction gas inlet lines being able to extend into the interior, but also that the end of a reduction gas inlet line can lie in the inner wall delimiting the interior, for example the opening of a bustle slot in the fireproof outer wall.

The reduction gas enters the interior of the reduction reactor shaft from the reduction gas inlet lines, through reduction gas outlets of these reduction gas inlet lines, and then flows through the bed of pieces of material containing metal oxide.

Furthermore a reduction gas channel body passing through the interior of the reduction reactor shaft is present for distribution of reduction gas into the interior of the reduction gas reactor shaft. It can pass through the interior as a secant or as a diameter, wherein passing through as a diameter is preferred, since reduction gas can then be brought into the bed more symmetrically and more evenly. The reduction gas channel body can run horizontally for example so that reduction gas can be introduced on a vertical level into the bed. The reduction gas channel body cannot however have a lowest point or a highest point in relation to the verticals, so that it has two part sections inclined downwards or upward from the wall of the reduction reactor shaft to the center of the reduction reactor shaft. Reduction gas can then enter the bed during operation at different vertical levels.

The reduction gas channel body passes through the interior of the reduction reactor shaft which is delimited by the inner walls of the reduction reactor shaft. The reduction gas channel body thus has two inner-wall-side ends. In accordance with the invention, at least one reduction gas inlet line for supplying reduction gas into the interior of the reduction gas reactor shaft is present essentially vertically below the reduction gas channel body at at least one inner-wall-side end of the reduction gas channel body.

Reduction gas is supplied to the interior of the reduction shaft below the reduction gas channel body.

During operation of the inventive apparatus a free space is formed below the reduction gas channel body in the bed which is located in the reduction reactor shaft and is primarily determined by the bed angle of the bed. The free space can also be called the reduction gas channel. The reduction gas channel body is suitable for effecting the formation of such a free space or reduction gas channel in a bed located in the reduction reactor shaft. The free space or reduction gas channel is used for the supply and distribution of reduction gas in the interior of the reduction reactor shaft. The reduction gas can be distributed in the free space over the entire length of the reduction gas channel body and enter evenly into the bed.

In this case the phrase essentially vertically below means that at least a part of the mouth of the reduction gas supply line is located vertically below the reduction gas channel body. Then in operation the reduction gas emerging from this mouth can enter into the bed when it rises into a free space formed below the reduction gas channel body and can be distributed in this free space which passes through the interior of the reduction reactor shaft below the reduction gas channel body. This enables it to enter the bed from the reduction gas channel over the entire length of the reduction gas channel.

In accordance with the invention the reduction gas channel body has a carrier tube through which a cooling medium can flow. Metal is preferably used as a material for the reduction gas channel body and specifically for the carrier tube.

The carrier tube is cooled in order to maintain the mechanical properties needed during operation. In addition, to achieve the mechanical properties needed, lower material temperatures make possible a smaller size than with an uncooled carrier tube. Increasing the temperature brings with it a reduction in the solidity of metal, so that to guarantee a specific minimum solidity at a higher temperature, the carrier tube would have to be built larger than if no cooling were present.

In the prior art it is known that reduction gas can be introduced into the reduction reactor shaft through a tube passing through the interior of a reduction reactor shaft, and if necessary, the tube may be cooled by a cooling medium. To supply hot reduction gas, such a tube must have exterior and interior insulation, so that the heat dissipation of hot reduction gas to the cool cooling medium is not too great. This is because such heat dissipation would lead to unnecessary cooling of the reduction gas. For thermodynamic and kinetic reasons, the reduction gas should enter the bed at a specific minimum temperature. To compensate for such cooling, the gas must be supplied at a higher temperature than if no cooling were to be undertaken. Furthermore the cooling medium must then be cooled back down more strongly and thus at greater expense for reuse in the cooling medium circuit.

A further disadvantage of such known methods of construction consists of a simple end-face-side exit of the reduction gas not being possible for a tube passing through the interior. In order to make possible a supply of reduction gas from inside the tube into the interior or into a bed, pass-throughs through the wall of the tube over the length of the tube are necessary. These pass-throughs however unfavorably lead to a mechanical weakening of the tube at the point at which the tube will be under the greatest stress during operation through the weight of the bed. In addition, pressure losses for the gas flow are produced by the pass-throughs, which reduce the evenness of gas distribution, specifically in the area of the center of the shaft.

The invention avoids such disadvantages since reduction gas is not supplied into the inside of the reduction reactor shaft by a tube passing through the interior of the reduction reactor shaft but is instead supplied by a reduction gas supply line present essentially vertically below the reduction gas channel body for supplying reduction gas below the reduction gas channel body into the interior of the reduction reactor shaft.

Therefore the reduction gas channel body or its carrier tube respectively can be built smaller than the prior-art tubes provided with insulation described above, since in the inventive design cooling only has to be provided inside and no volume for the reduction gas supply and insulation is to be provided. Reduction gas is distributed into the interior reduction reactor shaft via the free space or reduction gas channel, so that no pass-throughs or disadvantages associated therewith are present. This free space or reduction gas channel extends over the entire length of the reduction gas channel body, which in comparison with point-type supply of reduction gas via pass-throughs, leads to a more even distribution of the reduction gas.

The reduction gas channel body is suitable for effecting the formation of a free space or reduction gas channel in a bed located in the reduction reactor shaft.

The reduction gas channel body can for example be a half tube shell open at the bottom with walls extended downwards, preferably essentially in parallel, which half tube shell rests on a carrier tube.

Instead of forms of embodiment with half tube shells on carrier tubes, web plates could be fastened, for example welded, onto both sides of a carrier tube, in order to similarly guarantee a free space below the carrier tube in the bed.

The reduction gas channel body has a carrier tube body through which cooling medium can flow. To this end the carrier tube has cooling medium channels inside it through which cooling medium can flow. The carrier tube is supported on both sides resting against the outer wall, i.e. the jacket, of the reduction reactor shaft.

The cooling medium is supplied and taken away for example at the point at which the reduction gas channel body or its carrier tube rests against the jacket of the reduction reactor shaft.

Water is preferably used as the cooling medium.

In accordance with a preferred embodiment, a reduction gas supply line for supply of reduction gas into the interior of the reduction reactor shaft is present on both inner-wall-side ends of the reduction gas channel body essentially vertically below the reduction gas channel body. This makes for a more even supply to the reduction gas channel body or reduction gas channel respectively, since supply is from both ends.

It is basically true to say that with more even introduction of reduction gas into the bed, dust carried along with the reduction gas will also be introduced more evenly into the bed. This leads to fewer blockages of flow paths for the reduction gas arising and to the problems associated therewith being avoided.

Preferably the reduction gas outlets of the reduction gas inlet lines lying in the interior of the reduction reactor shaft all lie within a section of the vertical longitudinal extent of the reduction reactor shaft which, viewed vertically, has a thickness of up to 100% of the diameter of the reduction reactor shaft. Preferably the thickness of the section is up to 40% of the diameter of the reduction reactor shaft, especially preferably up to 30% of the diameter of the reduction reactor shaft, quite especially preferably up to 20% of the diameter of the reduction reactor shaft. The smaller the thickness of the section is, the easier it is to supply all reduction gas lines with reduction gas from one source.

In accordance with a an embodiment, reduction gas inlet lines are embodied as bustle slots.

In accordance with another embodiment, reduction gas inlet lines are embodied as half tube shells open at the bottom with walls extended downwards, preferably essentially in parallel, which half tube shells rest against carrier tubes. The carrier tubes preferably have cooling medium channels within them. In the half tube shells the end of the half tube shell lying in the interior of the reduction reactor shaft is provided with a transverse wall connecting the walls extended downwards. The carrier tubes extend from the edge of the reduction reactor shaft into the interior of the reduction reactor shaft, preferably radially. At their end lying in the interior of the reduction reactor shaft they are not supported i.e. they are embodied as so-called flying tubes.

In accordance with an embodiment at least a number of the reduction gas inlet lines emanate from an internal bustle, i.e. are bustle slots of an internal bustle.

All reduction gas inlet lines can also be bustle slots of an internal bustle. For a number X of reduction gas inlet lines the number A of reduction gas inlet lines which are bustle slots of an internal bustle is less than or equal to X, i.e. A≦X.

By comparison with an external bustle, an internal bustle requires a less complex embodiment of the pressure container of the reduction reactor shaft, and allows a less complex supply of reduction gas. In addition a greater number of bustle slots can be realized compared to an external bustle.

In another embodiment, at least a number of the reduction gas inlet lines emanate from an external bustle, i.e. are bustle slots of an external bustle.

All reduction gas inlet lines can also be bustle slots of an external bustle. For a number X of reduction gas inlet lines, the number B of reduction gas inlet lines which are bustle slots of an external bustle is less than or equal to X, i.e. B≦X.

Compared to an internal bustle, an external bustle has the advantage that the bustle slots can be cleaned more easily from outside and that the fireproof outer wall inside the reduction reactor shaft can be embodied in a less complicated manner.

Preferably, specifically in the event of dust-laden reduction gas being used, the bustle slots open out, as described in the introduction, into an area of the interior not filled with a bed during operation of the reduction shaft. This is achieved for example by the reduction shaft being manufactured, viewed vertically from above, along the longitudinal axis of the reduction shaft, with a jump in the expansion of the diameter of its interior.

According to a further embodiment a number of the reduction gas inlet lines are flying tubes. This means that not all reduction gas inlet lines are flying tubes. For a number X of reduction gas inlet lines, the number C of reduction gas inlet lines which are flying tubes is less than X, also C<X.

Preferably, with A<X at least one of the reduction gas inlet lines which is not a bustle slot of an internal bustle, is a flying tube, and especially preferably all, i.e. X−A=C.

Preferably, with B<X, at least one of the reduction gas inlet lines, which is not a bustle slot of an external bustle, is a flying tube; quite especially preferably all, i.e. X−B=C. By combination of bustle slots and flying tubes, reduction gas is able to be introduced at different distances from the inner wall of the reduction reactor shaft, which leads to evening out of the introduction and thus to a better reduction result. By comparison with an end-to-end reduction gas channel body, flying tubes are easier to install and allow better replacement possibilities, while they also bring benefits in relation to more even distribution of the reduction gas, compared to a reduction reactor shaft with just bustles.

In accordance with an embodiment, the reduction gas supply line originates from an internal bustle. The supply line is then for example, and possibly specifically embodied for this task, a bustle slot of the internal bustle, or it is a part section of this internal bustle. It is preferred that on both inner-wall-side ends of the reduction gas channel body there is a reduction gas supply line for supply of reduction gas into the interior of the reduction gas shaft present essentially vertically below the reduction gas channel body; then two reduction gas supply lines can be present, for example two part sections of an internal bustle.

In accordance with another embodiment, the reduction gas supply line originates outside the reduction reactor shaft, for example from an external bustle. It is then for example and possibly specifically embodied for this task, a bustle slot of the external bustle.

In accordance with a preferred embodiment, the reduction gas supply line for supply of reduction gas below the reduction gas channel body and a least a few, preferably all, reduction gas inlet lines are supplied with reduction gas from the same internal and/or external bustle.

This reduces the constructional outlay which would be necessary for supplies provided separately from one another.

In accordance with a preferred embodiment, the reduction gas channel body lies at least partly within that section of the vertical longitudinal extent of the reduction reactor shaft which, viewed vertically, has a thickness of up to 100%, preferably up to 40%, especially preferably up to 30%, quite especially preferably up to 20% of the diameter of the reduction reactor shaft, in which the reduction gas outlets of the reduction gas inlet lines lie. In this way reduction gas can be easily conveyed from the reduction gas outlets to the reduction gas channel body, or it can be easily conveyed from the source for reduction gas supplying the reduction gas inlet lines to the reduction gas channel body.

The internal or external bustle is provided with at least one supply for reduction gas through which the reduction gas is conveyed into the internal or external bustle. In accordance with a preferred embodiment, at least one supply is offset in relation to the circumference of the reduction reactor shaft to the position of the reduction gas supply line below an inner wall side end of the reduction gas channel body, preferably by 45°-90°, especially preferably by essentially 90°. In this way reduction gas flow is over the longest possible path in the internal or external bustle before it enters into the bed during operation below the hollow space formed by the reduction gas channel body. Through this, because of the flow speeds of the reduction gas in the bustle, dust deposits in the internal or external bustle are minimized.

In accordance with a preferred embodiment, the internal diameter of the reduction reactor shaft in the area of its longitudinal extent, in which reduction gas channel body and possibly flying tubes are present, is expanded in relation to other areas of its longitudinal extent. The expansion is intended to essentially compensate for the loss of cross-sectional surface available for upwards movement of the bed in the interior which is produced by the requirements of space of the reduction gas channel body and, if necessary, of the flying tubes. If for example this loss amounts to 10% of the surface of the cross-sectional surface in the interior, then the internal diameter should be expanded by around 2-10%. This enables reduction of blocking problems in the bed moving upwards, since surface area occupied by the flying tubes or the reduction gas channel body and thus not available for upwards movement of the bed will be compensated for again by the expansion. The area in which the internal diameter of the reduction reactor shaft is expanded preferably comprises a section of the vertical longitudinal extent of the reduction reactor shaft which, viewed in a vertical direction, has a thickness of up to 100%, preferably up to 40%, especially preferably up to 30%, quite especially preferably up to 20%, of the diameter of the reduction reactor shaft.

The expansion can also be present above the area of the longitudinal extent in which reduction gas channel body and possibly flying tubes are present.

A further object of the present invention is to provide a method for producing metal sponge or pig iron from a bed of pieces of material containing metal oxide in a reduction reactor shaft using a reduction gas, wherein a first part quantity of the reduction gas is introduced into the bed through a number of reduction gas inlet lines ending in the interior of the reduction reactor shaft, and characterized in that a second part quantity of the reduction gas is distributed into the bed by means of a reduction gas channel body passing through the reduction reactor shaft, and this second part quantity of the reduction gas is supplied essentially vertically below the reduction gas channel body into the interior of the reduction reactor shaft.

The second part quantity is supplied by means of at least one reduction gas supply line.

When the inventive apparatus is used, a free space or reduction gas channel is formed in the bed below the reduction gas channel body. The reduction gas can be distributed in this free space and enter into the bed from it. The reduction gas is thus distributed by means of the reduction gas channel body into the bed in the interior of the reduction reactor shaft.

When reduction gas inlet lines are embodied as bustle slots, reduction gas is introduced into the bed by means of the bustle slots.

When reduction gas inlet lines are embodied as half tube shells with walls extended downwards, for example as flying tubes, resting against carrier tubes, then like the reduction gas channel body, a free space is formed in the bed during operation. In this free space the reduction gas can be distributed and enter into the bed from the space.

In accordance with a preferred embodiment, the first part quantity and the second part quantity are delivered from the same internal and/or external bustle.

### BRIEF DESCRIPTION OF THE DRAWINGS

The invention will be explained in greater detail below on the basis of typical schematic diagrams of embodiments.

FIG. 1 shows a schematic diagram of a reduction reactor shaft in accordance with the prior art.

FIG. 2 shows a schematic diagram of an inventive reduction reactor shaft.

FIG. 3 shows a schematic diagram of a view of the apparatus depicted in FIG. 2, looking vertically downwards from above.

FIG. 4 shows a schematic diagram of a reduction gas channel body with free space embodied below in the bed.

FIG. 5 shows a schematic diagram of a view similar to that depicted in FIG. 3 of another embodiment of the inventive apparatus.

FIG. 6 shows a schematic diagram of a section of an inventive apparatus.

FIG. 7 shows a schematic diagram of a section along the dashed line A-A′ from FIG. 6.

FIG. 8 schematically shows cooling is not shown in FIGS. 2 to 7 for reasons of improved clarity.

### DESCRIPTION OF EMBODIMENTS

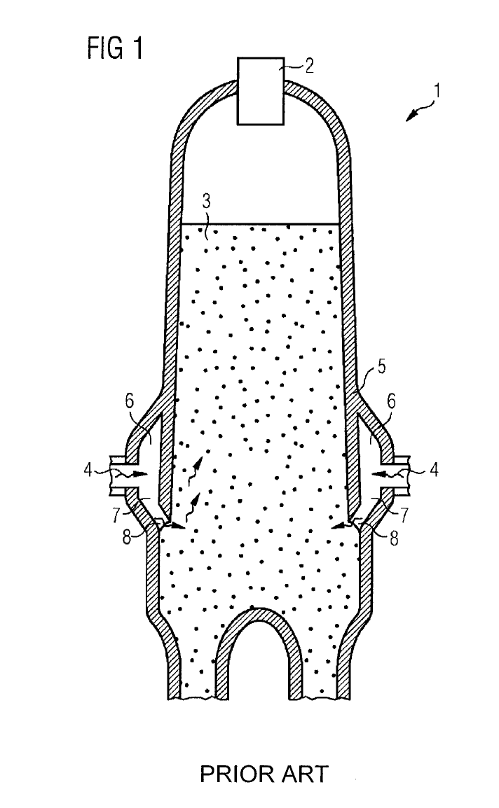

FIG. 1, in accordance with the prior art, shows that in a reduction reactor shaft 1, material in the form of pieces containing iron oxide introduced via a supply facility 2 form a bed 3. Reduction gas 4, represented by wavy-line arrows with solid ends, flows through the bed and, in doing so, reduces the lump ore to iron sponge. For reasons of clarity the figure does not show parts of the apparatus for taking away used reduction gas from the reduction reactor shaft. The reduction gas 4 is conveyed in an internal bustle 6 formed in the fireproof outer wall 5 of the reduction reactor shaft 1. A number of reduction gas inlet lines for introduction of reduction gas into the interior of the reduction reactor shaft, here bustle slots 7, which end in the interior of the reduction reactor shaft 1, emanate from the internal bustle 6. By means of these bustle slots 7, in accordance with the prior art, the reduction gas is introduced into the bed. As a result of a step in the diameter of the interior of the reduction reactor shaft, a ring-shaped space 8, which is not filled by the bed, is formed around the entire circumference of the reduction reactor shaft.

In FIG. 2 depicting an inventive apparatus which is largely similar to the above figure, the reference characters used in FIG. 1 are largely omitted from reasons of clarity. Outlets 9a, 9b, 9c, 9d of a number of bustle slots 7 are labeled. For reasons of clarity, not every outlet labeled has been given a separate reference character. The outlets 9a, 9b, 9c, 9d of the bustle slot are the reduction gas outlets of the bustle slots 7. They lie in a horizontal plane 10.

A reduction gas channel body 11 passes through the interior of the reduction reactor shaft 1. The reduction gas channel body is embodied as a half tube shell 13 open toward the bottom, with walls extending downwards and resting against a carrier tube 12. The carrier tube 12 is supported on both sides on the jacket 14 of the reduction reactor shaft, which is not shown as extra detail. The reduction gas channel body 11 runs horizontally and passes through the interior as a diameter. It lies within that section of the vertical longitudinal extent of the reduction reactor shaft which, when viewed vertically, has a thickness of up to 100% of the diameter of the reduction reactor shaft, and in the case shown below 30%, in which the mouths of the bustle slots lie. On both the inner-wall-side ends of the reduction gas channel body 11 a reduction gas supply line for the supply of reduction gas into the interior of the reduction shaft is present vertically below the reduction gas channel body 11, in this case a part section of the internal bustle 6 which is open vertically below the reduction gas channel body 11 to the interior of the reduction reactor shaft 1. This opening 15 is shown schematically by a rectangle in FIG. 6. The carrier tube 12 has water flowing through it as a cooling medium during operation, but for improved clarity this is not shown separately.

FIG. 3 shows a view of the apparatus depicted in FIG. 2 from above, looking vertically downwards. The two feeds 16a and 16b of the bustle 5 are offset in relation to the circumference of the reduction reactor shaft 1 by essentially 90° from the position of the reduction gas supply line, not visible in FIG. 3, below the inner-wall-side ends 17a, 17b of the reduction gas channel body 1. The carrier tube of the reduction gas channel body has water flowing through it as a cooling medium during operation, but for improved clarity this is not shown additionally.

FIG. 4 shows a schematic diagram of how, for the reduction gas channel body 11, a free space 18 is embodied below it in the bed. The carrier tube 12 carries the half tube shell 13 with extended, essentially parallel walls. It is also shown that the extended side walls on the carrier tube are supported by means of webs to prevent bending under the pressure of the bed 3.

A corresponding free space is formed for a similar construction of the flying tubes described above.

The carrier tube 12 has water flowing through it as a cooling medium during operation, but for improved clarity this is not shown additionally.

FIG. 5 shows a schematic diagram of a view similar to that depicted in FIG. 3 of another embodiment of the inventive apparatus.

Here an external bustle is present, which consists of the two parts 19a and 19b. It is supplied by the feeds 22 and 23 with reduction gas. The external bustle could also be embodied as a complete ring, but this is not shown in an extra figure however. The reduction gas channel body 11 connects the two parts 19a and 19b. Bustle slots 20 emanate from the external bustle, which open out in a ring-shaped area indicated by a dashed line which is formed in the bed as a result of a sudden expansion of the interior, within the jacket 14 of the reduction reactor shaft. Likewise, for the purposes of introduction of reduction gas, there are outgoing flying tubes 21, which are supported like the reduction gas channel body on the jacket 14. They end in the interior of the reduction reactor shaft. The carrier tube of the reduction gas channel body has water flowing through it as a cooling medium during operation, but for improved clarity this is not shown additionally.

In the diagrams depicted in FIGS. 2 to 5, when the inventive process for producing iron sponge is carried out, a first part quantity of the reduction gas is introduced by means of a number of reduction gas inlet lines ending in the interior of the reduction reactor shaft from bustle slots of external or internal bustles, or flying tubes emanating from an external bustle into the bed. A second part quantity of the reduction gas is distributed in the bed by means of a reduction gas channel passing through the reduction reactor shaft after the second part quantity has been essentially supplied vertically below the reduction gas channel body into the interior of the reduction reactor shaft.

FIGS. 6 and 7 show schematically how the part section of the internal bustle 6 functioning in FIG. 3 and FIG. 4 as a reduction gas supply line for supply of reduction gas into the interior of the reduction reactor shaft is embodied vertically below the reduction gas channel body 11. The first part quantity of the reduction gas and the second part quantity of the reduction gas are thus delivered from the same internal bustle. The internal bustle 6 has an expansion pointing downwards. The reduction gas channel body 11 lies so that the free space 18 under the reduction gas channel body 11 lies in approximately the same plane as the ring-shaped area into which the mouths of the bustle slots 7 open out.

FIG. 6 shows a section of an inventive apparatus. An internal bustle 6 is present in the fireproof outer wall 5 in the jacket 14 of the reduction reactor shaft. A part section of the internal bustle 6 is expanded downwards. The wall delimiting the internal bustle 6 from the interior is shown crosshatched. Shown in the internal bustle 6 are a number of openings of bustle slots 7 in the area of the floor of the internal bustle 6. Delimitations of the floor are shown by dashed lines. A bustle slot 7 with mouth 9e is shown in cross-section.

At the part section of the internal bustle 6 which is expanded downwards a reduction gas channel body 11 enters the interior through the wall shown crosshatched. For improved clarity, only a part section of the reduction channel body 11 with carrier tube 12 and half tube shell 13 are shown. Vertically below the reduction gas channel body 11 the wall shown crosshatched has an opening 15 through which the reduction gas is introduced into the interior. This opening 15 is a reduction gas supply line emanating from the internal bustle 6. The reduction gas channel body 11 lies so that the free space 18 below reduction gas channel body 11 lies approximately in the same plane as the mouths of the bustle slots, of which, for improved clarity, only one, namely mouth 9e, is shown.

FIG. 7 shows a section along the line A-A′ shown interrupted in FIG. 7. The flow path of reduction gas 4, shown by wavy arrows with solid heads, from the bustle 6 outwards through opening 15 into an area below the reduction gas channel body 11 is illustrated.

The carrier tube of the reduction gas channel body has water flowing through it during operation as a cooling medium in FIGS. 6 and 7, but for improved clarity this is not shown additionally.

While the cooling has not been shown in FIGS. 2 to 7 for reasons of improved clarity, the cooling is sketched in FIG. 8 in a cross-section through an inventive apparatus. How cooling water is introduced into the carrier tube 24 and is taken away from the carrier tube 24 is shown by arrows. The carrier tube 24 is installed in the reduction reactor shaft 25 so that, at the two inner-wall-side ends of the reduction gas channel body to which the carrier tube belongs, reduction gas supply lines for supply of reduction gas below are present. In FIG. 8 this is shown schematically by the internal bustle 25 and the bustle slots 26 emanating from it. In the part of the cross-section covered by the carrier tube 24 the contours of the bustle 25 or of the bustle slots are shown cross hatched. Inside it the carrier tube 24 possesses a cooling medium supply space 27 and a cooling medium removal space 28. These are separated from one another by a cooling channel tube 29 arranged concentrically with the carrier tube 24 in the carrier tube 24. In the exterior cooling medium supply space the cooling water flows up to the end of the supply tube, changes its direction of movement there and flows back through the cooling medium removal space and is conveyed out of the carrier tube.

Although the invention has been illustrated and described in greater detail by the preferred exemplary embodiments, the invention is not restricted by the disclosed examples and other variations can be derived therefrom by the person skilled in the art, without departing from the scope of protection of the invention.

### LIST OF REFERENCE CHARACTERS

1 Reduction reactor shaft
2 Supply facility
3 Bed
4 Reduction gas
5 Fire-proof outer walling
6 Internal bustle
7 Bustle slot
8 Ring-shaped space
9a,9b,9c,9d Mouths of the bustle slots 7
10 Horizontal plane 10, in which the mouths 9a,9b,9c,9d of the bustle slots 7 lie
11 Reduction gas channel body
12 Carrier tube
13 Half tube shell
14 Jacket (of the reduction reactor shaft 1)
15 Opening
16a,16b Feeds of the bustles 5
17a,17b Inner-wall-side ends of the reduction gas channel body 1
18 Free space
19a,19b Parts of an external bustle
20 Bustle slots
21 Flying tube
22 Feed
23 Feed
24 Carrier tube
25 Internal bustle
36 Bustle slots
27 Cooling medium supply space
28 Cooling medium removal space
29 Cooling channel tube

### LIST OF CITED DOCUMENTS

### Patent Literature

EP0904415B1
W02009000409
W00036159
W00036157

1. An apparatus for production of metal sponge or pig iron from pieces of material containing metal oxide, using a reduction gas, the apparatus comprising:
a reduction reactor shaft;
a plurality of reduction gas inlet lines each ending in an interior of the reduction reactor shaft and each configured for introducing reduction gas into the interior of the reduction reactor shaft;
a reduction gas channel body passing through the interior of the reduction reactor shaft and configured for forming a free space in the bed and configured for distributing reduction gas into the interior of the reduction reactor shaft;
the reduction gas channel body has at least one inner-wall-side end, vertically below the reduction gas channel body in a free space in the bed;
at least one reduction gas supply line configured for supplying reduction gas located below the reduction gas channel body into the interior of the reduction reactor shaft; and
a carrier tube at the reduction gas channel body through which a cooling medium can flow.

2. The apparatus as claimed in claim 1, further comprising a plurality of reduction gas outlets of the reduction gas inlet lines lying in the interior of the reduction gas reactor shaft and all lying within a section of a vertical longitudinal extent of the reduction reactor shaft, which, viewed in the vertical direction, has a thickness of up to 100% of the diameter of the reduction reactor shaft.

3. The apparatus as claimed in claim 1, further comprising an internal and/or external bustle of the reactor shaft;
the reduction gas supply line configured for supply of reduction gas is located below the reduction gas channel body; and
at least a few of the reduction gas inlet lines are connected to be supplied with reduction gas from the same internal and/or external bustle.

4. The apparatus as claimed in claim 2, further comprising the reduction gas channel body lies at least partly within a section of the vertical longitudinal extent of the reduction reactor shaft which, viewed vertically, has a thickness of up to 100% of the diameter of the reduction reactor shaft, and in which the reduction gas outlets of the reduction gas inlet lines lie.

5. The apparatus as claimed in claim 1, further comprising at least one feed for reduction gas to the internal and/or external bustle, and through which reduction gas is conveyed into the internal and/or external bustle, the at least one feed is offset, with reference to a circumference of the reduction reactor shaft, to the position of the reduction gas supply line and below an inner-wall-side end of the reduction gas channel body.

6. The apparatus as claimed in claim 1, further comprising the internal diameter of the reduction reactor shaft in the area of its longitudinal extent, at which reduction gas channel body is present, is expanded in relation to other areas of its longitudinal extent.

7. A method for producing metal sponge or pig iron from a bed of pieces of material containing metal oxide in a reduction reactor shaft using a reduction gas, wherein the method comprises:
introducing a first part quantity of the reduction gas into the bed through a number of reduction gas inlet lines ending in the interior of the reduction reactor shaft;
distributing a second part quantity of the reduction gas into the bed by a reduction gas channel body passing through the interior of the reduction reactor shaft and operative for forming a free space in the bed; and
supplying the second part quantity of the reduction gas vertically below the reduction gas channel body into the interior of the reduction reactor shaft.

8. The method as claimed in claim 7, further comprising delivering the first part quantity and the second part quantity from the same internal and/or external bustle.

9. The apparatus as claimed in claim 6, further comprising flying tubes at the reduction gas inlet lines.
